(19) United States
(12) Patent Application Publication
(10) Pub. No.: US 2026/0219063 A1
(43) Pub. Date: Jul. 30, 2026

(54) INFORMATION PROCESSING DEVICE AND METHOD FOR PROCESSING MAP DATA USED FOR AUTONOMOUS DRIVING OF VEHICLE

(71) Applicants: DENSO CORPORATION, Kariya-city (JP); J-QuAD DYNAMICS Inc., Tokyo (JP)

(72) Inventors: Takayuki WATANABE, Tokyo (JP); Taiki SUZUKI, Tokyo (JP)

(21) Appl. No.: 19/463,790

(22) Filed: Jan. 29, 2026

(30) Foreign Application Priority Data
Jan. 30, 2025 (JP) 2025-014130

(51) Int. Cl. G01C 21/00; B60W 60/00

(52) U.S. Cl. CPC G01C 21/3815; B60W 60/00; G01C 21/3833; B60W 2556/40

(57) ABSTRACT

An information processing device for processing map data used for autonomous driving of a vehicle is provide, where the map data includes node information regarding a plurality of nodes corresponding to points on a road and link information regarding links connecting the nodes. A map data updater updates the map data stored in a map database from old map data to new map data. An update determiner performs an update determination as to whether autonomous driving availability information associated with the link information is updatable, based on a degree of match between the link information in the old map data and the link information in the new map data. An availability-information updater carries over, from the old map data to the new map data, the autonomous driving availability information associated with the link information determined to be updatable by the update determiner.

### CROSS-REFERENCE TO RELATED APPLICATION

This application is based on and claims the benefit of priority from earlier Japanese Patent Application No. 2025-014130 filed January 30, 2025, the description of which is incorporated herein by reference.

### BACKGROUND

### Technical Field

The present disclosure relates to an information processing device, an information processing method, and an information processing program product, for processing map data used for autonomous driving of a vehicle.

### Related Art

In recent years, autonomous driving technology has been becoming increasingly practical. In this regard, for example, a technique is known in which, when autonomous driving is canceled on the vehicle side in response to a driver operation or a situation around the vehicle, information relating to a location at which the autonomous driving is canceled is transmitted to a server. In such a technique, transmitting information relating to the location at which autonomous driving is canceled to the server allows the information to be reflected in the server as an autonomous-driving-unavailability location.

On the other hand, even at an autonomous driving unavailability location, the autonomous driving unavailability may later be removed, that is, the state may return to an autonomous driving available state. In this case, if information indicating removal of autonomous driving unavailability cannot be transmitted to the server, and thus the removal cannot be reflected in the server, information registered in the server as an autonomous driving unavailability location is not updated, which may result in the information becoming outdated. Under such circumstances, there is a need for a technique that reflects, in a server, that the autonomous driving unavailability has been removed when the autonomous driving unavailability is removed at an autonomous driving unavailability location.

A known autonomous driving availability determination system includes an on-board device and a server. The on-board device determines, using at least camera information, whether an autonomous driving unavailability location is included in at least one of a travel lane in which a host vehicle is traveling, an adjacent lane, and an oncoming lane. The on-board device transmits, to the server, a determination result indicating that the area in which the host vehicle is traveling corresponds to an autonomous driving unavailability location, as unavailability notification information. The server receives the unavailability notification information transmitted from the on-board device and records the received unavailability notification information.

Here, the on-board device determines whether an autonomous driving unavailability zone is present in front of the vehicle, using forward information of a travel route included in map data stored in a map data storage unit. When it is determined that an autonomous driving unavailability zone is located forward of the host vehicle, the on-board device acquires, from map data stored in the map data storage unit, cause information indicating a cause of the autonomous driving unavailability. Then, the on-board device determines, using vehicle surroundings information, whether an autonomous driving unavailability cause based on the acquired cause information persists, and transmits a determination result to the server. This allows the fact that the autonomous driving unavailability has been removed to be appropriately reflected in the server.

### BRIEF DESCRIPTION OF THE DRAWINGS

In the accompanying drawings:

FIG. 1 is a schematic block diagram illustrating a device configuration of an information processing system according to one embodiment of the present disclosure;

FIG. 2 is a schematic block diagram illustrating an example of a functional configuration implemented by an on-board-device-side control unit illustrated in FIG. 1;

FIG. 3 is a schematic block diagram illustrating an example of a functional configuration implemented by a server-side control unit illustrated in FIG. 1;

FIG. 4 is a conceptual diagram illustrating a first specific example of autonomous driving availability information processing by the information processing system illustrated in FIG. 1;

FIG. 5 is a conceptual diagram illustrating a second specific example of autonomous driving availability information processing by the information processing system illustrated

in FIG. 1;

FIG. 6 is a conceptual diagram illustrating a third specific example of autonomous driving availability information processing by the information processing system illustrated in FIG. 1;

FIG. 7 is a conceptual diagram illustrating a fourth specific example of autonomous driving availability information processing by the information processing system illustrated in FIG. 1;

FIG. 8 is a conceptual diagram illustrating a fifth specific example of autonomous driving availability information processing by the information processing system illustrated in FIG. 1;

FIG. 9 is a flowchart illustrating an overview of autonomous driving availability information processing by the information processing system illustrated in FIG. 1;

FIG. 10 is a schematic block diagram illustrating another example of a functional configuration implemented by the server-side control unit illustrated in FIG. 1; and

FIG. 11 is a conceptual diagram illustrating another specific example of autonomous driving availability information processing by the information processing system illustrated in FIG. 1.

### DESCRIPTION OF SPECIFIC EMBODIMENTS

In the above-described known technique, as disclosed in Japanese Patent No. 7302509, autonomous driving availability information is recorded in association with a link

ID identifying a link on a map, a lane ID identifying a lane, and a travel direction. However, handling of such autonomous driving availability information during map updates is not specified. In a case where, due to updating of map data, the link ID or lane ID representing a road or lane for which autonomous driving availability information has been registered is changed, autonomous driving availability may not be appropriately determined on the subject road. In another case where the autonomous driving availability information becomes registered for a different road, autonomous driving availability may not be appropriately determined on that road either. In addition, in a case where all autonomous driving availability information is discarded at the time of map updating, autonomous driving availability may not be appropriately determined even for roads whose on-site conditions have not changed. As a result, it becomes necessary to newly collect and register autonomous driving availability information again, which is inefficient.

The present disclosure has been made in view of the circumstances exemplified above. That is, the present disclosure provides a technique that enables appropriate updating (that is, carrying over or discarding) of autonomous driving availability information when updating map data within a system that manages such information in association with map data.

A first aspect of the present disclosure provides an information processing device for processing map data used for autonomous driving of a vehicle, the map data including node information regarding a plurality of nodes corresponding to points on a road and link information regarding links connecting the nodes, each link connecting a pair of adjacent nodes among the plurality of nodes. The information processing device includes: a map data updater configured to update the map data stored in a map database from old map data to new map data; an update determiner configured to perform an update determination as to whether autonomous driving availability information associated with the link information is updatable, based on a degree of match between the link information in the old map data and the link information in the new map data; and an availability-information updater configured to carry over, from the old map data to the new map data, the autonomous driving availability information associated with the link information determined to be updatable by the update determiner.

A second aspect of the present disclosure provides an information processing method for processing map data used for autonomous driving of a vehicle, the map data including node information regarding a plurality of nodes corresponding to points on a road and link information regarding links connecting the nodes, each link connecting a pair of adjacent nodes among the plurality of nodes. The information processing method includes: updating the map data stored in a map database from old map data to new map data; performing an update determination as to whether autonomous driving availability information associated with the link information is updatable, based on a degree of match between the link information in the old map data and the link information in the new map data; and carrying over, from the old map data to the new map data, the autonomous driving availability information associated with the link information determined to be updatable as a result of the update determination.

A third aspect of the present disclosure provides a computer program product comprising instructions which, when executed by a computer, cause the computer to carry out a method for processing map data used for autonomous driving of a vehicle, the map data including node information regarding a plurality of nodes corresponding to points on a road and link information regarding links connecting the nodes, each link connecting a pair of adjacent nodes among the plurality of nodes. The method includes: updating the map data stored in a map database from old map data to new map data; performing an update determination as to whether autonomous driving availability information associated with the link information is updatable, based on a degree of match between the link information in the old map data and the link information in the new map data; and carrying over, from the old map data to the new map data, the autonomous driving availability information associated with the link information determined to be updatable as a result of the update determination.

In each part of the present application document, the reference signs in parentheses attached to the components or the like merely indicate examples of the correspondence between the components or the like and the specific components described in relation to the embodiments described below. Therefore, the present disclosure is not limited by the above reference signs.

### Embodiments

Hereinafter, exemplary embodiments and specific examples of the present disclosure will be described with reference to the accompanying drawings as appropriate. It should be noted that the following embodiments, their modifications, and the accompanying drawings are schematically or simplistically presented for the purpose of concisely explaining the content of the present disclosure, and therefore do not limit the scope of the present disclosure in any way. Accordingly, it goes without saying that the configurations illustrated in the drawings do not necessarily coincide with the specific device configurations that may actually be manufactured and marketed. That is, unless the applicant explicitly limits the scope of the present application during prosecution, the present disclosure should not be construed in a limited manner based on the illustrations in the drawings and the descriptions of the corresponding device configurations, functions, or operations set forth below.

### System Configuration

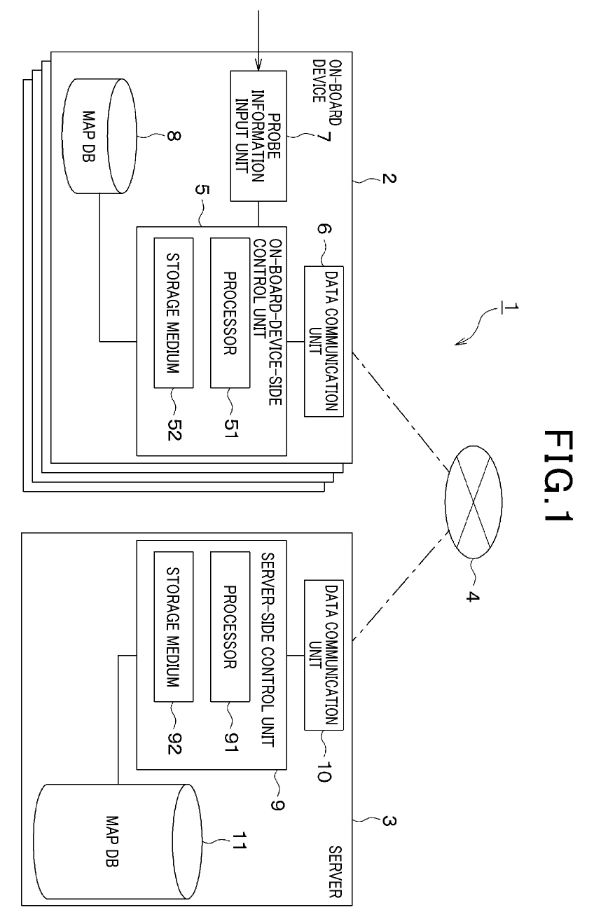

First, referring to FIG. 1, an information processing system 1 is configured such that an on-board device 2 on a vehicle side and a server 3 on a network side are capable of data communication via a communication network 4. The on-board devices 2 and the server 3 have a many-to-one relationship, and the server 3 is capable of data communication with a plurality of on-board devices 2 via the communication network 4. Hereinafter, a vehicle equipped with the on-board device 2 is referred to as a host vehicle.

In the present embodiment, the host vehicle is configured to be capable of implementing “autonomous driving,” which is an automation level corresponding to Level 3 or Level 4 defined in the standard “SAE J3016” published by SAE International. SAE is an abbreviation for Society of Automotive Engineers. “Driving automation” is a concept that includes “autonomous driving” and “driving assistance.” A level X in “SAE J3016” is hereinafter simply referred to as “SAE Level X.” X is any one of 0 to 5. The contents of SAE Levels 0 to 5 are specifically as described below.

In this description, a driver is an occupant of the host vehicle who is responsible for or performs a dynamic driving task. A “dynamic driving task” refers to all operational and tactical functions that need to be performed in real time when operating the host vehicle in road traffic, excluding strategic functions. The driving behaviors may be classified into three types of functions: strategic, tactical, and operational functions. The “strategic” function includes route planning and selection of waypoints and, more specifically, includes determining or selecting a travel plan such as whether to go, when to go, where to go, and how to go. The “tactical” function relates to vehicle operations in traffic situations, such as deciding whether to perform overtaking or lane changes and when to do so, selecting an appropriate speed, and checking mirrors during travel. The “operational” function relates to instantaneous reactions, such as making fine adjustments to steering, braking, accelerator operation, and acceleration in order to maintain a position within a road lane or to avoid sudden obstacles or hazardous events on a vehicle travel path.

“OEDR” is an abbreviation for Object and Event Detection and Response and is also referred to as “object and event detection and response.” OEDR includes monitoring of a driving environment. Monitoring of the driving environment includes detection, recognition, and classification of objects and events. Further, monitoring of the driving environment includes preparation to respond to objects and events as necessary. A “limited domain” is a specific condition under which a certain driving automation system or a function thereof is designed to operate and is also referred to as an operational design domain or ODD. ODD is an abbreviation for Operational Design Domain. The limited domain includes, for example, at least one of a plurality of constraint conditions such as geographical, environmental, speed-related, and time-related conditions.

SAE Level 0: Manual driving … The driver performs all dynamic driving tasks.

SAE Level 1: Driving assistance … A driving automation system persistently performs, in a specific limited domain, one of a longitudinal vehicle motion control subtask and a lateral vehicle motion control subtask among dynamic driving tasks. The longitudinal vehicle motion control subtask includes starting, acceleration/deceleration, and stopping. The lateral vehicle motion control subtask includes steering. However, the driving automation system does not simultaneously perform both the longitudinal vehicle motion control subtask and the lateral vehicle motion control subtask.

SAE Level 2: Advanced driving assistance … The driving automation system persistently performs, in a specific limited domain, both the longitudinal vehicle motion control subtask and the lateral vehicle motion control subtask among dynamic driving tasks. The driver is expected to supervise the driving automation system by performing OEDR, which is a subtask of the dynamic driving task.

SAE Level 3: Conditional autonomous driving … The driving automation system persistently performs all dynamic driving tasks in a specific limited domain. In principle, the driver is not obligated to perform OEDR such as monitoring surroundings. Monitoring surroundings is monitoring of a traffic environment around the host vehicle. However, when continuation at the driving automation level becomes difficult, the driving automation system requests a driver takeover with sufficient temporal margin. The driver needs to appropriately respond to the request.

SAE Level 4: Advanced autonomous driving … The driving automation system persistently performs all dynamic driving tasks in a specific limited domain. In the limited domain, responses to a situation in which continuation at the driving automation level becomes difficult are performed by the driving automation system.

SAE Level 5: Fully autonomous driving … The driving automation system persistently performs all dynamic driving tasks without being limited to a specific limited domain. Responses to a situation in which continuation at the driving automation level becomes difficult are also performed by the driving automation system without limitation to a specific limited domain.

The on-board device 2 includes an on-board-device-side control unit 5, an on-board-device-side data communication unit 6, a probe information input unit 7, and an on-board-device-side map database 8. The server 3 includes a server-side control unit 9, a server-side data communication unit 10, and a server-side map database 11.

The on-board-device-side control unit 5 is communicably connected with the on-board-device-side data communication unit 6, the probe information input unit 7, and the on-board-device-side map database 8 so as to exchange signals or information. The on-board-device-side control unit 5 is a so-called ECU and is provided to control overall operations of the on-board device 2. ECU is an abbreviation for Electronic Control Unit.

In the present embodiment, the on-board-device-side control unit 5 has a configuration as an on-board microcomputer including at least an on-board-device-side processor 51 and an on-board-device-side storage medium 52. The on-board-device-side processor 51 includes at least one arithmetic unit having a configuration as a CPU or an MPU, and peripheral circuits thereof (for example, a timer circuit and the like). CPU is an abbreviation for Central Processing Unit. MPU is an abbreviation for Micro Processor Unit. The on-board-device-side processor 51 loads and executes a computer program to implement functions necessary for controlling overall operations of the on-board device 2.

The on-board-device-side storage medium 52 includes, among various non-transitory tangible storage media such as a ROM, a RAM, and a non-volatile rewritable memory, at least the RAM and ROM and/or non-volatile rewritable memory. ROM is an abbreviation for Read Only Memory. RAM is an abbreviation for Random Access Memory. The non-volatile rewritable memory is a storage device that allows information to be rewritten while power is on and retains the information without allowing rewriting while power is off, and includes, for example, a magnetic recording medium and a flash memory. In the ROM and/or the non-volatile rewritable memory, a computer program to be executed by the on-board-device-side processor 51 is stored.

The on-board-device-side data communication unit 6 is provided to control data communication with the server 3 via the communication network 4. Specifically, the on-board-device-side data communication unit 6 is an on-board communication module also referred to as a DCM and is configured to be capable of information communication with the server 3 via base stations around the host vehicle by wireless communication compliant with a predefined communication standard. DCM is an abbreviation for Data Communication Module.

The probe information input unit 7 is provided to input probe information such as vehicle surroundings information, vehicle driving information, and vehicle location information to the on-board-device-side control unit 5. Specifically, the probe information input unit 7 inputs, as vehicle surroundings information, camera images captured by an on-board camera that captures images forward of the host vehicle, sensor information detected by sensors that detect objects around the host vehicle, radar information detected by a radar that detects objects around the host vehicle, and the like.

Further, the probe information input unit 7 inputs, as vehicle driving information, vehicle speed information detected by a vehicle speed sensor. Further, the probe information input unit 7 inputs, as vehicle location information, position coordinates measured based on positioning signals received by a satellite positioning system. The satellite positioning system is also referred to as GNSS. GNSS is an abbreviation for Global Navigation Satellite System.

As the satellite positioning system, at least one of GPS, QZSS, GLONASS, Galileo, IRNSS, and the BeiDou Navigation Satellite System may be used. GPS is an abbreviation for Global Positioning System. QZSS is an abbreviation for Quasi-Zenith Satellite System. GLONASS is an abbreviation for Global Navigation Satellite System. IRNSS is an abbreviation for Indian Regional Navigation Satellite System.

The on-board-device-side map database 8 is a map database that stores map data in a rewritable manner and has a configuration as non-volatile rewritable memory. The on-board-device-side map database 8 has a smaller data storage capacity than the server-side map database 11 and stores map data targeting a limited area corresponding to a location of the host vehicle. That is, the on-board device 2 is configured to download, from the server 3, map data around the location of the host vehicle among map data stored in the server-side map database 11 and store the downloaded map data in the on-board-device-side map database 8.

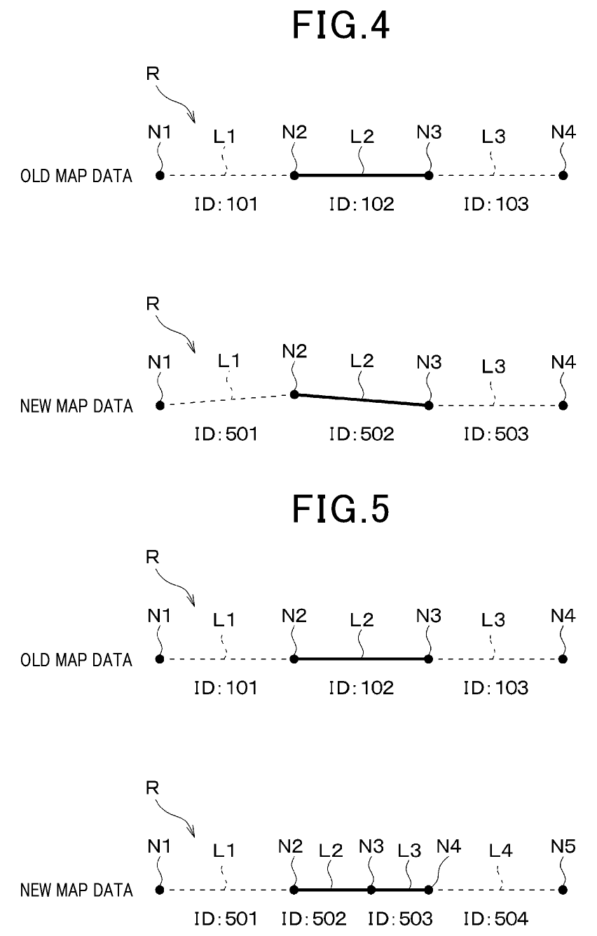

Map data stored in the on-board-device-side map database 8 and the server-side map database 11 has a data structure as so-called high-definition map data used for autonomous driving of the host vehicle. Such map data includes at least node information relating to a plurality of nodes N corresponding to locations on a road R, and link information relating to links L connecting the nodes N, as illustrated in FIG. 4. Specifically, the map data includes node information, link information, feature information, and the like.

The node information includes data such as node IDs, node coordinates, node names, node types, connection link IDs, intersection types, presence or absence of a traffic signal at each intersection, center coordinates of each intersection, and presence or absence of a stop regulation. The node IDs are unique numbers assigned to respective nodes N on the map. The node coordinates of each node are described by latitude and longitude. The connection link IDs correspond to link IDs of respective links L connected to nodes N.

The link information includes data such as link IDs, shape information, node coordinates of a start end and a terminal end of each link L, road attributes, and the like. The link IDs are unique numbers identifying the respective links L. The shape information corresponding to the shape of the link L may be represented by a series of latitude/longitude coordinate points, or may be represented by a road shape such as whether the link is straight or curved, a curvature radius of the curve, or the like, a link length, a link direction, and the like. The link length indicates a length of the link L. The link information may be described in a manner subdivided on a lane-by-lane basis. The road attributes include a road name, a road type, a road width, a number of lanes, presence or absence of right-turn/left-turn exclusive lanes and a number thereof, a speed regulation value, and the like.

The feature information includes lane marking information, landmark information, and POI information. POI is an abbreviation for Point of Interest. The lane marking information includes, for each lane marking, a lane marking ID and a group of coordinate points representing an installation position. The lane marking information includes pattern information such as broken lines, solid lines, and road studs. The lane marking information is associated with lane information such as a lane ID or a link ID at a lane level.

A landmark refers to a feature that may be used as a marker for identifying a location of the host vehicle on a map. Landmarks include predefined three-dimensional structures arranged along a road. The three-dimensional structures installed along the road include, for example, guardrails, curb stones, trees, utility poles, road signs, traffic signals, and the like. The road signs include guide signs such as direction signs and road name signs. Further, road edges and lane markings may also be included as landmarks.

The landmark information represents a location and a type for each landmark. Shapes and locations of respective features are represented by groups of coordinate points. The POI information is information indicating locations and types of features that affect a vehicle travel plan, such as branch points for exiting from a main line of an expressway, merging points, speed limit change points, lane change points, congestion sections, construction sections, intersections, tunnels, toll gates, and the like. The POI information includes type information and location information.

The map data is recorded in association with autonomous driving availability information. The autonomous driving availability information includes a link ID, a lane ID, a travel direction, autonomous driving availability (i.e., information indicating whether autonomous driving is available), an unavailability reason indicating that an area in which the host vehicle is traveling corresponds to an autonomous driving unavailability location, and a removal reason indicating that the autonomous driving unavailability has been removed at the autonomous driving unavailability location. The lane ID is information identifying a lane. Details of determination of autonomous driving availability and details of the unavailability reason and the removal reason will be described later.

In the present embodiment, a case in which both an unavailability reason and a removal reason are provided is exemplified. However, when the unavailability reason is resolved, the autonomous driving unavailability is deemed to be removed at the location where the unavailability reason has been resolved, and thus the removal reason may be omitted. Further, when the removal reason is resolved, the area in which the host vehicle is traveling, at the location where the removal reason has been resolved, is deemed to correspond to an autonomous driving unavailability location, and therefore the unavailability reason may be omitted.

The server-side control unit 9 is communicably connected with the server-side data communication unit 10 and the server-side map database 11 to exchange signals or information. The server-side control unit 9 is provided to control overall operations of the server 3.

In the present embodiment, the server-side control unit 9 has a configuration as a microcomputer including at least a server-side processor 91 and a server-side storage medium 92. The server-side processor 91 includes at least one arithmetic unit having a configuration as a CPU or an MPU, and peripheral circuits thereof (for example, a timer circuit and the like). The server-side processor 91 loads and executes a computer program to implement functions necessary for controlling overall operations of the server 3.

A server-side storage medium 92 includes, among various non-transitory tangible storage media such as a ROM, a RAM, and a non-volatile rewritable memory, at least the RAM and the ROM and/or the non-volatile rewritable memory. In the ROM and/or the non-volatile rewritable memory, a computer program to be executed by the server-side processor 91 is stored.

The server-side data communication unit 10 is provided to control data communication with the on-board device 2 via the communication network 4. The server- side map database 11 is a map database that stores map data in a rewritable manner and has a configuration as non-volatile rewritable memory. The server-side map database 11 has a larger data storage capacity than the on-board-device-side map database 8 and stores map data targeting a wide area corresponding to locations of an unspecified number of vehicles. That is, the server 3 is configured to download, via the communication network 4, all or part of map data for all of Japan and/or other countries stored in a data center (not illustrated) and store the downloaded map data in the server-side map database 11. The server 3 may be such a data center.

### On-Board-Device-Side Control Unit

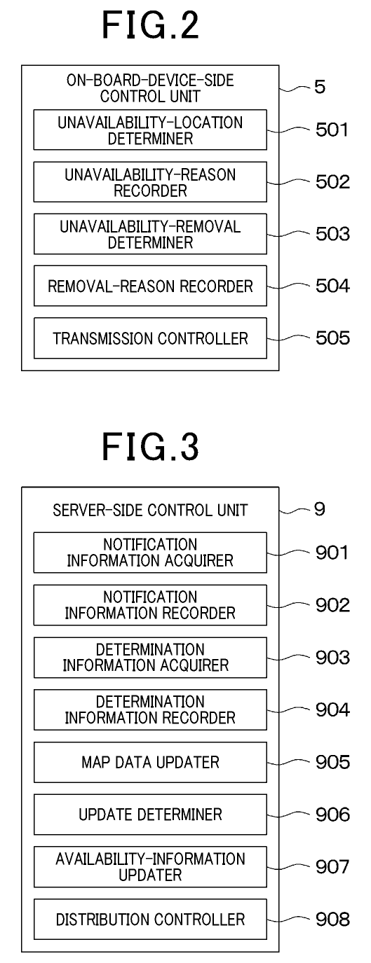

FIG. 2 illustrates an example of a functional block configuration implemented when the on-board-device-side processor 51 provided in the on-board-device-side control unit 5 illustrated in FIG. 1 loads and executes a computer program from the on-board-device-side storage medium 52. As illustrated in FIG. 2, the on-board-device-side control unit 5 includes, as a functional configuration implemented by executing the computer program, an unavailability-location determiner 501, an unavailability-reason recorder 502, an unavailability-removal determiner 503, a removal-reason recorder 504, and a transmission controller 505.

When vehicle surroundings information such as camera images, sensor information, and radar information is input to the probe information input unit 7, the unavailability-location determiner 501 determines whether the area in which the host vehicle is traveling corresponds to an autonomous driving unavailability location, using the input vehicle surroundings information. For example, when a dropped object is present or a disabled vehicle is stopped, the unavailability-location determiner 501 determines that the area in which the host vehicle is traveling corresponds to an autonomous driving unavailability location. The area in which the host vehicle is traveling may include not only a travel lane in which the host vehicle is traveling but also an adjacent lane adjacent to the travel lane and an oncoming lane of an oncoming roadway.

When, for example, a dropped object is present or a disabled vehicle is stopped in the travel lane, the unavailability-location determiner 501 determines that the travel lane is unavailable for autonomous driving. When, for example, a dropped object is present or a disabled vehicle is stopped in the adjacent lane or the oncoming lane, the unavailability-location determiner 501 determines that the adjacent lane or the oncoming lane is unavailable for autonomous driving. That is, the unavailability-location determination unit 501 may be configured to determine whether autonomous driving is unavailable not only for the travel lane in which the host vehicle is traveling but also for adjacent lanes and oncoming lanes.

Factors that cause an autonomous driving unavailability location include, in addition to dropped objects and disabled vehicles, road construction, illegally parked vehicles on ordinary roads, traffic congestion, traffic accidents, road surface freezing, road surface snow accumulation, bad weather, worn road paint, autonomous driving cancellation operations by a driver, and the like. Here, as an example, a case in which autonomous driving availability is determined on a lane-by-lane basis is exemplified. Alternatively, the autonomous driving availability may be determined on a road-by-road basis. The road-by- road basis means, for a road having multiple lanes on one side, a unit formed by grouping multiple lanes having the same travel direction, and means, for a road having one lane on one side, a unit of the road itself.

Autonomous driving availability may be determined based on whether conditions of a limited domain are satisfied. As the conditions of the limited domain, for example, those listed below can be cited.

Condition A: The vehicle is traveling on an expressway or an automobile-only road having at least two lanes in one direction and equipped with a median strip and guardrails and the like.

Condition B: Including adjacent lanes, an inter-vehicle distance to a preceding vehicle traveling ahead of the host vehicle and/or a following vehicle traveling behind the host vehicle is short, and a so-called congested driving state is present.

Condition C: A vehicle speed of the host vehicle is not higher than 60 kilometers per hour.

Condition D: Neither a traffic signal nor a pedestrian is present within a detection range of on-board sensors such as a millimeter-wave radar or LiDAR. LiDAR is an abbreviation for Light Detection and Ranging or Laser Imaging Detection and Ranging and may also be referred to as a laser radar sensor.

Specifically, as an example, autonomous driving may be determined to be unavailable when a dropped object is present on the travel lane of the host vehicle, or when image recognition performance of the on-board camera is degraded due to backlighting or the like. Conditions for determining autonomous driving to be unavailable and the like may be changed as appropriate. Further, a configuration may be adopted in which autonomous driving availability is determined by combining a plurality of conditions in a composite manner.

When the unavailability-location determiner 501 determines that the area in which the host vehicle is traveling corresponds to an autonomous driving unavailability location, the unavailability-reason recorder 502 records an unavailability reason in association with the autonomous driving unavailability location. Specifically, the unavailability-reason recorder 502 appropriately updates tabular data associating “link ID, lane ID, travel direction, autonomous driving availability, unavailability reason, and removal reason” according to a determination result by the unavailability-location determiner 501.

When vehicle surroundings information such as camera images, sensor information, and radar information is input to the probe information input unit 7, the unavailability-removal determiner 503 determines whether autonomous driving unavailability has been removed at an autonomous driving unavailability location, using the input vehicle surroundings information. In other words, the unavailability-removal determiner 503 determines whether the unavailability reason has been resolved, that is, whether an autonomous driving available state exists.

Specifically, for example, when the dropped object that was present is collected or the disabled vehicle that was stopped is evacuated, the unavailability-removal determiner 503 determines that autonomous driving unavailability has been removed at the autonomous driving unavailability location. The autonomous driving unavailability location may include not only the travel lane in which the host vehicle is traveling but also an adjacent lane adjacent to the travel lane and an oncoming lane of an oncoming roadway.

When the unavailability-removal determiner 503 determines that autonomous driving unavailability has been removed at an autonomous driving unavailability location, the removal-reason recorder 504 records a removal reason in association with a location where the autonomous driving unavailability has been removed. Specifically, the removal-reason recorder 504 appropriately updates tabular data associating “link ID, lane ID, travel direction, autonomous driving availability, unavailability reason, and removal reason” according to a determination result by the unavailability-removal determiner 503.

The transmission controller 505 controls operations for transmitting, to the server 3, a determination result of autonomous driving availability and the unavailability reason and the removal reason. That is, the transmission controller 505 causes the on-board-device-side data communication unit 6 to transmit, to the server 3 as notification information, the determination result and the unavailability reason from the unavailability-location determiner 501, or the determination result and the removal reason from the unavailability-removal determiner 503.

Specifically, when the unavailability reason is recorded by the unavailability-reason recorder 502 in association with the autonomous driving unavailability location, the transmission controller 505 causes the on-board-device-side data communication unit 6 to transmit, to the server 3 as unavailability notification information, the determination result and the unavailability reason of the unavailability-location determiner 501. Further, the transmission controller 505 causes the on-board-device-side data communication unit 6 to transmit, to the server 3, unavailability determination information used when the unavailability-location determiner 501 determines that the area in which the host vehicle is traveling corresponds to an autonomous driving unavailability location. That is, for example, when presence of a dropped object is detected based on a camera image and the area in which the host vehicle is traveling is determined to correspond to an autonomous driving unavailability location, the transmission control unit 505 causes the on-board-device-side data communication unit 6 to transmit, to the server 3 as the unavailability determination information, a camera image or the like in which the dropped object is captured.

When the removal reason is recorded by the removal-reason recorder 504 in association with a location where autonomous driving unavailability has been removed, the transmission controller 505 causes the on-board-device-side data communication unit 6 to transmit, to the server 3 as removal notification information, the determination result and the removal reason of the unavailability-removal determiner 503. Further, the transmission controller 505 causes the on-board-device-side data communication unit 6 to transmit, to the server 3, removal determination information used when the unavailability-removal determiner 503 determines that autonomous driving unavailability has been removed at the autonomous driving unavailability location. That is, for example, when collection of the dropped object is detected based on a camera image and autonomous driving unavailability is determined to have been removed, the transmission controller 505 causes the on-board- device-side data communication unit 6 to transmit, to the server 3 as the removal determination information, a camera image or the like in which the dropped object is not captured.

### Server-Side Control Unit

FIG. 3 illustrates an example of a functional block configuration implemented when the server-side processor 91 provided in the server-side control unit 9 illustrated in FIG. 1 loads and executes a computer program from the server-side storage medium 92. In the present embodiment, the server-side control unit 9 corresponds to an information processing device that processes map data used for autonomous driving in the present disclosure.

As illustrated in FIG. 3, the server-side processor 91 includes, as functional blocks implemented by executing the computer program, a notification information acquirer 901, a notification information recorder 902, a determination information acquirer 903, a determination information recorder 904, a map data updater 905, an update determiner 906, an availability-information updater 907, and a distribution controller 908.

The notification information acquirer 901 acquires unavailability notification information by the server-side data communication unit 10 receiving the unavailability notification information transmitted from the on-board device 2. The notification information acquirer 901 acquires removal notification information by the server-side data communication unit 10 receiving the removal notification information transmitted from the on-board device 2. When the unavailability notification information or the removal notification information is acquired by the notification information acquirer 901, the notification information recorder 902 records, in the server-side map database 11, the unavailability reason or the removal reason together with the determination result included in the acquired unavailability notification information or removal notification information.

The determination information acquirer 903 acquires unavailability determination information by the server-side data communication unit 10 receiving the unavailability determination information transmitted from the on-board device 2. The determination information acquirer 903 acquires removal determination information by the server-side data communication unit 10 receiving the removal determination information transmitted from the on-board device 2. When the unavailability determination information or the removal determination information is acquired by the determination information acquirer 903, the determination information recorder 904 records, in the server-side map database 11, the acquired unavailability determination information or removal determination information.

The map data updater 905 updates map data stored in the server-side map database 11 from old map data to new map data. Specifically, for example, when map data stored in a data center (not illustrated) is updated to a latest version and update information is received from the data center via the communication network 4, the map data updater 905 rewrites the map data based on the received update information.

The update determiner 906 performs an update determination, which is a determination as to whether autonomous driving availability information associated with the link information is updatable, based on a degree of match between link information in the old map data and link information in the new map data. The availability-information updater 907 carries over autonomous driving availability information associated with link information determined to be updatable in the update determination from the old map data to the new map data. Details of the update determination, that is, determination of the degree of match, and details of carrying over the autonomous driving availability information will be described later.

The distribution controller 908 causes the server-side data communication unit 10 to distribute map data stored in the server-side map database 11 to an unspecified number of on-board devices 2 or to an on-board device 2 requesting map data. In this case, since the map data stored in the server-side map database 11 is associated with the autonomous driving availability information, the autonomous driving availability information is associated with map data distributed from the server 3 to the on-board device 2.

That is, in the information processing system 1 functioning as an autonomous driving availability determination system, the on-board devices 2 and the server 3 have a many-to-one relationship. Therefore, for example, when the server 3 receives, from the on-board device 2 mounted to a vehicle A while the vehicle A is traveling at a location A, unavailability notification information or removal notification information relating to the location A, the server 3 records the received unavailability notification information or removal notification information. By distributing the unavailability notification information and the removal notification information recorded in this manner to an on-board device 2 mounted to a vehicle B that is going to travel at the location A, the server 3 may provide the unavailability notification information and the removal notification information to the vehicle B.

### Overview of Operations

An overview of operations by the device configuration according to the present embodiment will be described below together with the device configuration and effects achieved by an information processing method and an information processing program executed thereby. In the following description, the device configuration according to the present embodiment and the information processing method and the information processing program executed thereby may be collectively referred to as “the present embodiment.”

### 1-1: Autonomous Driving Unavailability Location Determination Processing

In the on-board device 2, the on-board-device-side control unit 5 repeatedly performs processing to determine an autonomous driving unavailability location at a predefined cycle. The on-board-device-side control unit 5 acquires vehicle surroundings information when vehicle surroundings information such as camera images, sensor information, and radar information is input to the probe information input unit 7, and determines whether the area in which the host vehicle is traveling corresponds to an autonomous driving unavailability location, using the acquired vehicle surroundings information.

When the on-board-device-side control unit 5 determines that the area in which the host vehicle is traveling corresponds to an autonomous driving unavailability location, the on-board-device-side control unit 5 records the location as an autonomous driving unavailability location in association with an unavailability reason. The on-board-device- side control unit 5 causes the on-board-device-side data communication unit 6 to transmit, to the server 3 as unavailability notification information, the determination result and the unavailability reason.

The on-board-device-side control unit 5 causes the on-board-device-side data communication unit 6 to transmit, to the server 3 as unavailability determination information, determination information used when determining that the area in which the host vehicle is traveling corresponds to an autonomous driving unavailability location. For example, when the on-board-device-side control unit 5 determines, based on a camera image, that the area in which the host vehicle is traveling corresponds to an autonomous driving unavailability location, the on-board-device-side control unit 5 causes the on-board-device-side data communication unit 6 to transmit, to the server 3 as the unavailability determination information, the camera image.

When the on-board-device-side control unit 5 determines that the area in which the host vehicle is traveling does not correspond to an autonomous driving unavailability location, the on-board-device-side control unit 5 determines whether the area in which the host vehicle is traveling is recorded as an autonomous driving unavailability location. When the on-board-device-side control unit 5 determines that the area in which the host vehicle is traveling is recorded as an autonomous driving unavailability location, the on-board-device-side control unit 5 records a removal reason in association with the location as a location where autonomous driving unavailability has been removed. The on-board-device-side control unit 5 causes the on-board-device-side data communication unit 6 to transmit, to the server 3 as removal notification information, the determination result and the removal reason.

The on-board-device-side control unit 5 causes the on-board-device-side data communication unit 6 to transmit, to the server 3 as removal determination information, determination information used when determining that autonomous driving unavailability has been removed. For example, when the on-board-device-side control unit 5 determines, based on a camera image, that autonomous driving unavailability has been removed, the on-board-device-side control unit 5 causes the on-board-device-side data communication unit 6 to transmit, to the server 3 as the removal determination information, the camera image.

### 1-2: Notification Information Reception Processing

In the server 3, the server-side control unit 9 repeatedly performs processing for receiving notification information and determination information transmitted from the on-board device 2 at a predefined cycle. The server-side control unit 9 determines whether the notification information and the determination information transmitted from the on-board device 2 have been received.

When the server-side control unit 9 determines that unavailability notification information and unavailability determination information transmitted from the on-board device 2 have been received by the server-side data communication unit 10, the server-side control unit 9 identifies a location indicated by the received unavailability notification information and calculates a reception count per unit time of the unavailability notification information indicating the same location. When the server-side control unit 9 determines that the reception count per unit time is not less than a predefined count, the server-side control unit 9 determines that the received unavailability notification information is credible, records the unavailability notification information, and records the unavailability reason in association with the autonomous driving unavailability location.

The server-side control unit 9 records the unavailability determination information and thereby records determination information that was used to determine that the location indicated by the received unavailability notification information is an autonomous driving unavailability location. The server-side control unit 9 can determine credibility of the unavailability notification information by verifying the unavailability notification information using the unavailability determination information.

For example, when the unavailability determination information is a camera image, the server-side control unit 9 can determine that the unavailability notification information is credible by performing image analysis on the camera image and determining that the image is an image in which a dropped object is captured. Verification of the unavailability notification information using the unavailability determination information may be automatically performed in the server 3 using a predefined verification algorithm, or may be manually performed, for example, by an operator visually checking the information.

Verifying the unavailability notification information using the unavailability determination information in this manner can reduce a situation in which a location at which autonomous driving is continuable is erroneously registered as an autonomous driving unavailability location in the server-side map database 11. For example, when a driver performs an autonomous driving cancellation operation due to occupant’s mood, such as an occupant’s sudden desire to stop at a service area, not registering the location at which the cancellation operation is performed as an autonomous driving unavailability location in the server-side map database 11 can avoid erroneous registration of that location as an autonomous driving unavailability location.

Further, instead of adopting the unavailability notification information transmitted from the on-board devices 2 as is, verifying the unavailability notification information using the unavailability determination information in this manner can increase reliability and accuracy of the unavailability notification information. The same applies to a case of verifying removal notification information using removal determination information described later, and reliability and accuracy of the removal notification information can be increased by verifying the removal notification information using the removal determination information.

When the server-side control unit 9 determines that removal notification information and removal determination information transmitted from the on-board device 2 have been received by the server-side data communication unit 10, the server-side control unit 9 identifies a location indicated by the received removal notification information and calculates a reception count per unit time of the removal notification information indicating the same location. When the server-side control unit 9 determines that the reception count per unit time is not less than a predefined count, the server-side control unit 9 determines that the received removal notification information is credible, records the removal notification information, and records a removal reason in association with a location where autonomous driving unavailability has been removed.

The server-side control unit 9 records the removal determination information and records determination information used when it is determined that autonomous driving unavailability has been removed. The server-side control unit 9 can determine credibility of the removal notification information by verifying the removal notification information using the removal determination information.

For example, when the removal determination information is a camera image, the server-side control unit 9 can determine that the removal notification information is credible by performing image analysis on the camera image and determining that the image is an image in which a dropped object is not captured. Verification of the removal notification information using the removal determination information may also be automatically performed in the server 3 using a predefined verification algorithm, or may be manually performed, for example, by an operator visually checking the information.

When the server 3 records the unavailability notification information and the removal notification information in this manner, the server 3 distributes the recorded unavailability notification information and the recorded removal notification information to an unspecified number of on-board devices 2. That is, the server 3 collects the unavailability notification information and the removal notification information from an unspecified number of on-board devices 2 and provides the collected unavailability notification information and the collected removal notification information to an unspecified number of on-board devices 2.

When the on-board device 2 receives unavailability notification information and removal notification information distributed from the server 3, the on-board device 2 updates autonomous driving availability information of map data stored in the on-board-device-side map database 8 in accordance with the received unavailability notification information and removal notification information and controls autonomous driving.

For example, when an autonomous driving unavailability location is present on a travel route during autonomous driving, the on-board device 2 switches from autonomous driving to manual driving, and when a location where autonomous driving unavailability has been removed is present on the travel route during manual driving, the on-board device 2 switches from manual driving to autonomous driving.

In an alternative embodiment, the server 3 may limit distribution targets of the unavailability notification information not to an unspecified number of on-board devices 2 but to on-board devices 2 that are scheduled to pass through an autonomous driving unavailability location. The on-board devices 2 scheduled to pass through the autonomous driving unavailability location may include an on-board device 2 moving toward the autonomous driving unavailability location on a road on which the autonomous driving unavailability location is set, an on-board device 2 for which a planned travel route including the autonomous driving unavailability location is set, and the like. The server 3 may limit distribution targets of the removal notification information not to an unspecified number of on-board devices 2 but to on-board devices 2 to which unavailability notification information relating to a location indicated by the removal notification information has already been distributed.

Limiting distribution targets of the unavailability notification information and the removal notification information in this manner can reduce communication load and communication traffic of the on-board device 2 and the server 3.

### 1-3: Map Data Update Processing

Details of map data update processing by the server-side control unit 9 and autonomous driving availability information update processing accompanying the map data update processing will be described below with reference to FIGS. 1 to 3 as well as FIGS. 4 to 10.

When map data stored in a data center (not illustrated) is updated to a latest version, update information is transmitted from the data center to the server 3 via the communication network 4. When the server 3 receives the update information via the server-side data communication unit 10, the server 3 causes the server-side control unit 9, that is, the map data updater 905, to update map data stored in the server-side map database 11.

Here, the update determiner 906 determines whether autonomous driving availability information associated with the link information is updatable, based on a degree of match between link information in old map data and link information in new map data. Such a degree of match may be determined based on shape information, attribute information, identification-number information, and the like of the link. The attribute information is information regarding road attributes such as a road type. The “degree of match” may be expressed as “match” and “mismatch,” or may use a continuous value or a discrete value such as a percentage display where a perfect match is 100%, or an amount of variation of a characteristic value such as position coordinates.

FIGS. 4 to 6 illustrate examples in which the degree of match is determined based on shape information. In this example, in the old map data, a certain road of interest R is composed of a first link L1, a second link L2, and a third link L3 having link IDs 101, 102, and 103 in order from left in the drawing. The first link L1 is a link L connecting a first node N1 and a second node N2. The second link L2 is a link L connecting the second node N2 and a third node N3. The third link L3 is a link L connecting the third node N3 and a fourth node N4. It is assumed that autonomous driving availability information is associated (that is, assigned) with the second link L2. A link L associated with autonomous driving availability information is indicated by a thick solid line in the drawing.

In the example of FIG. 4, in corresponding new map data, link IDs of the first link L1, the second link L2, and the third link L3 are 501, 502, and 503 in order from left in the drawing. However, since a coordinate position of the second node N2 is slightly shifted from that in the old map data, shape information of the first link L1 and the second link L2 does not perfectly match.

However, the degree of match does not require a perfect match of the shape information, that is, 100%, and it is possible to recognize identity of the link shape when the degree of match is not less than a threshold, that is, when an amount of variation is not greater than a threshold. Therefore, when an amount of variation in the link shape of the second link L2 between the old map data and the new map data is not greater than the threshold, autonomous driving availability information associated with the second link L2 in the old map data may be carried over as-is to the second link L2 in the new map data.

In the example of FIG. 5, in corresponding new map data, the road of interest R is composed of a first link L1, a second link L2, a third link L3, and a fourth link L4 having link IDs 101, 102, 103, and 104 in order from left in the drawing. It is assumed that identity is recognized between the old and new map data for shape information of the first link L1 and position information of the first node N1 and the second node N2. Likewise, it is assumed that identity of shape information and position information is recognized between the third link L3 connecting the third node N3 and the fourth node N4 in the old map data and the fourth link L4 connecting the fourth node N4 and a fifth node N5 in the new map data.

On the other hand, the second link L2 connecting the second node N2 and the third node N3 in the old map data is divided, in the new map data, into a second link L2 and a third link L3 that are connected to each other. It is assumed that identity exists in position information between the third node N3 in the old map data and the fourth node N4 in the new map data. That is, the shape information between the second node N2 and the fourth node N4 in the new map data corresponds to adding one new node N at an intermediate position on the second link L2 in the old map data.

In this example, identity of the shape information is recognized as a whole between the second link L2 in the old map data and the second link L2 and the third link L3 in the new map data. Therefore, it is appropriate to carry over autonomous driving availability information associated with the second link L2 in the old map data to the second link L2 and the third link L3 in the new map data.

In this manner, even when the link information between old and new map data does not represent a one-to-one relationship but rather a one-to-many or many-to-one relationship, it is possible to appropriately update the autonomous driving availability information by recognizing identity of the shape information as a whole.

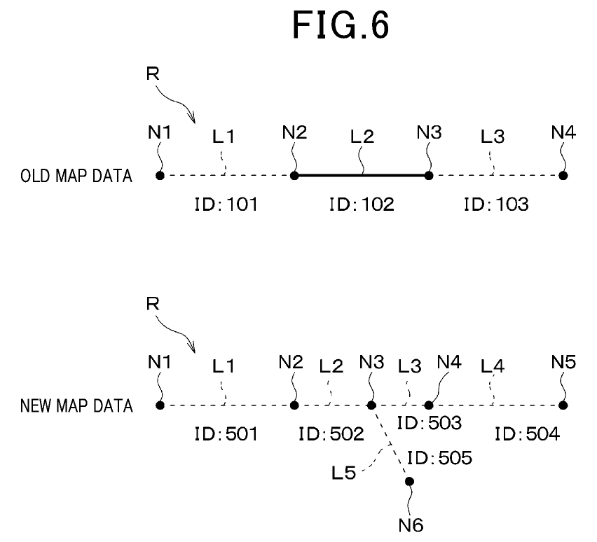

FIG. 6 illustrates an example in which identity of the shape information is not recognized. Specifically, as in the example of FIG. 5, the second link L2 connecting the second node N2 and the third node N3 in the old map data is divided, in the new map data, into the second link L2 and the third link L3. Identity of the first link L1 between the old and new map data, and identity between the third link L3 in the old map data and the fourth link L4 in the new map data are also the same as in the example of FIG. 5.

However, in the new map data, a fifth link L5 branches from the third node N3 and extends to a sixth node N6. That is, in this specific example, the second link L2, which was a single road in the old map data, is changed in the new map data to a branching road in which the fifth link L5 branches at an intermediate point.

In such a case, the update determiner 906 determines that autonomous driving availability information is not updatable. Then, the availability-information updater 907 discards the autonomous driving availability information associated with the second link L2 in the old map data and does not carry it over to the second link L2, the third link L3, or the fifth link L5. In this manner, by discarding autonomous driving availability information associated with link information determined to be not updatable in the update determination, it is possible to suitably avoid associating erroneous autonomous driving availability information with new map information.

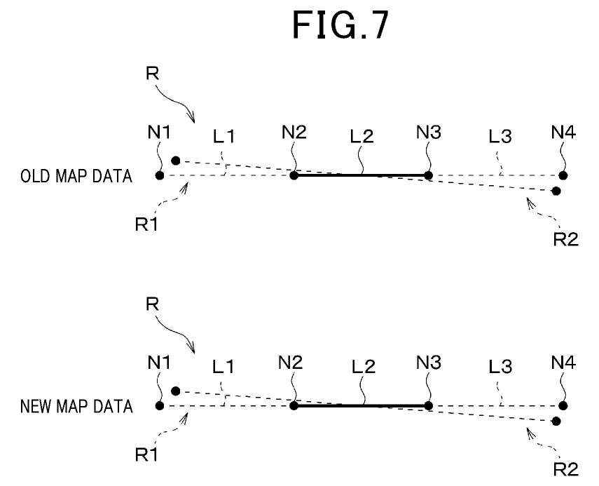

FIG. 7 illustrates an example in which the degree of match is determined based on road attribute information. That is, for example, in addition to a first road R1 as a road of interest R for which autonomous driving availability information is registered, there may exist another road, that is, a second road R2, that is grade-separated from or runs in parallel with the first road R1. In such a case, if the determination is made only based on the degree of match of the link shape, there may be a risk of erroneous determination. In this respect, erroneous determination can be suppressed based on differences in attribute information, such as road types, between the first road R1 and the second road R2.

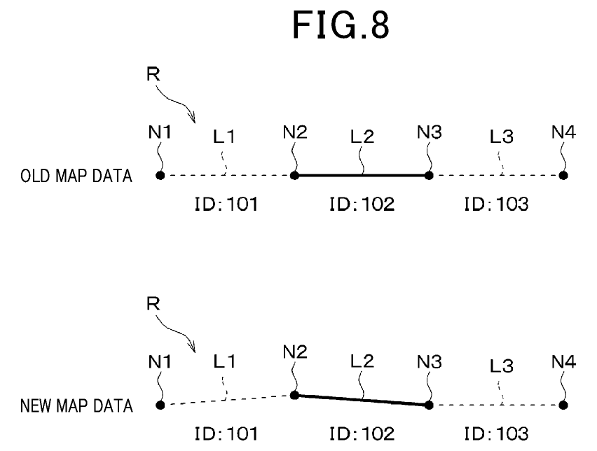

FIG. 8 illustrates an example in which the degree of match is determined based on the identity of the identification number information, that is, the link IDs, assigned to links L. In the example of FIG. 8, link IDs of the first link L1, the second link L2, and the third link L3 in the corresponding new map data are the same as those in the old map data, that is, 101, 102, and 103.

In this manner, when creating new map data, there is a case where it is guaranteed that the same identification number is assigned to a link L representing the same road. Therefore, in this case, whether autonomous driving availability information is updatable can be readily determined by determining whether a link ID, in the old map data, for which autonomous driving availability information is registered exists in the new map data.

### Example Operation

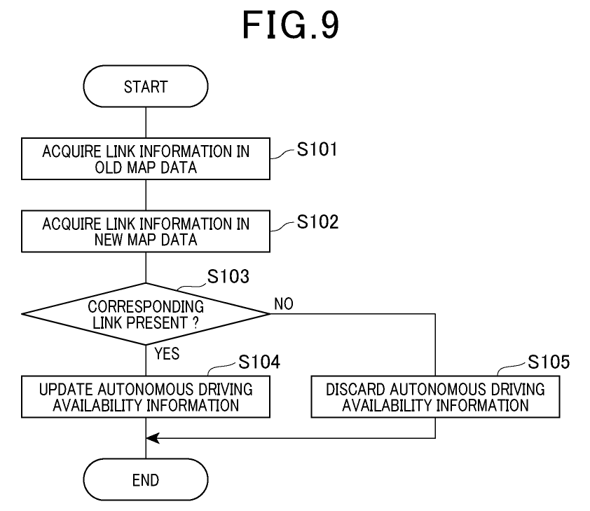

FIG. 9 illustrates a specific example of an operation of determining whether autonomous driving availability information is updatable.

In the flowchart illustrated in FIG. 9, “S” is an abbreviation for “step.” Hereinafter, the server-side processor 91 will be simply referred to as a “processor,” and the server-side storage medium 92 will be simply referred to as a “storage medium.”

The processor performs an information processing method according to the present embodiment by loading and initiating a computer program according to the present embodiment from the storage medium. When the program is initiated, the processor first sequentially performs process steps 101 to 103.

At step 101, the processor acquires link information in the old map data. At step 102, the processor acquires link information in the new map data. At step 103, the processor compares link information in the old and new map data and determines whether a link L, in the new map data, corresponding to a link L, in the old map data, for which autonomous driving availability information is registered exists. That is, the processor determines identity of the link information between the old and new map data.

When identity of the link information between the old and new map data is recognized (that is, YES at step 103), the processor proceeds to step 104. At step 104, the processor determines that autonomous driving availability information is “updatable” and carries over the autonomous driving availability information associated with the old map data to the new map data.

In contrast, when identity of the link information between the old and new map data is not recognized (that is, NO at step 103), the processor proceeds to step 105. At step 105, the processor determines that autonomous driving availability information is “not updatable” and discards the autonomous driving availability information associated with the old map data.

### Modifications

The present disclosure is not limited to the embodiments and specific examples described above. Therefore, the above embodiments and the like can be modified as appropriate. Representative modifications will be described below. In the description of the following modifications, differences from the above embodiments and the like will be mainly described. Further, in the above embodiments and the following modifications, the same reference numerals are given to parts that are the same as or equivalent to each other. Therefore, in the description of the following modifications, for components having the same reference numerals as those in the above embodiments and the like, the descriptions in the above embodiments and the like can be applied as appropriate unless there is a technical inconsistency or special additional explanation.

The present disclosure is not limited to specific applications and device configurations shown in the above embodiment. That is, for example, the host vehicle may be a so-called passenger car or may be a large vehicle. That is, there is no particular limitation on a type, shape, or size of a vehicle body of the host vehicle.

In the above embodiment, the on-board-device-side control unit 5 has a configuration as an on-board microcomputer including at least the on-board-device-side processor 51 that executes a computer program and the on-board-device-side storage medium 52 that stores and holds the computer program.

The same applies to the server-side control unit 9. However, the present disclosure is not limited to such an aspect.

That is, all or part of the on-board-device-side control unit 5 may be configured to include a digital circuit, such as an ASIC or an FPGA, configured to be able to implement the above functions or operations. ASIC is an abbreviation for Application Specific Integrated Circuit. FPGA is an abbreviation for Field Programmable Gate Array. In other words, in the on-board-device-side control unit 5, an on-board microcomputer portion and a digital circuit portion may coexist. The same applies to the server-side control unit 9.

Each of the above-described functional configurations and processes may be realized by a dedicated computer provided by configuring a processor and a memory programmed to execute one or more functions embodied by computer programs. Alternatively, each of the functional configurations and processes described above may be realized by a dedicated computer provided by configuring a processor with one or more dedicated hardware logic circuits. Alternatively, each of the functional configurations and processes described above may be realized by one or more dedicated computers configured by combining a processor and a memory programmed to execute one or more functions with a processor configured by one or more hardware logic circuits. Further, the computer program may also be stored in a computer-readable non-transitory tangible storage medium as an instruction to be executed by a computer. That is, each of the above-described functional configurations and processes can also be represented as a computer program including procedures for implementing each of the above-described functions or methods, or as a non-transitory tangible storage medium storing said program.

The computer program according to the present disclosure, which enables the various operations, procedures, or processes described in the above embodiment to be executed, may be downloaded or updated via V2X communication. "V2X" stands for Vehicle-to-Everything. Alternatively, such a computer program may be downloaded or updated via a terminal device installed at any of locations such as a manufacturing facility, maintenance facility, or dealership of the host vehicle V. The program may also be stored on a memory card, optical disc, magnetic disc, or the like.

In the above-described embodiment, update processing of autonomous driving availability information is performed on the server 3 side when map data is updated on the server 3 side, and the on-board device 2 side is configured merely to receive the information updated on the server 3 side. However, the present disclosure is not limited to such a configuration.

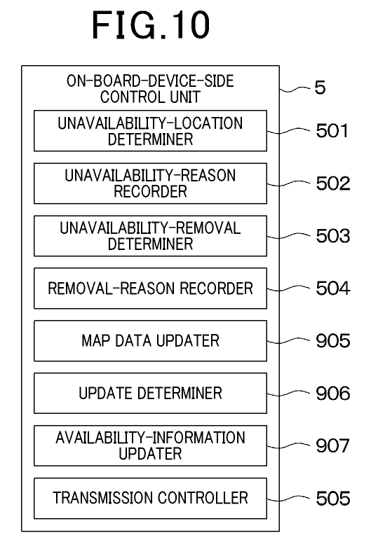

Specifically, for example, map data may be updated on the on-board device 2 side. In such a case, a configuration may be adopted in which update processing of autonomous driving availability information in the map data stored in the on-board-device-side database 8 is performed on the on-board device 2 side, and the result thereof is transmitted to the server 3 side. FIG. 10 shows an example of a functional configuration of the on-board-device-side control unit 5 in this case. That is, the map data updater 905, the update determiner 906, and the availability-information updater 907 may be implemented as functional blocks of the on-board-device-side controller 5. Therefore, the map data updater 905, the update determination unit 906, and the availability-information updater 907 may be provided in either one or both of the on-board-device-side controller 5 and the server-side controller 9.

The present disclosure is not limited to the specific operational modes shown in the above-described embodiments. That is, for example, the autonomous driving availability information does not need to be associated with the entirety of the link L, and may instead be associated with a partial section of the link L by using information such as a distance from a starting point.

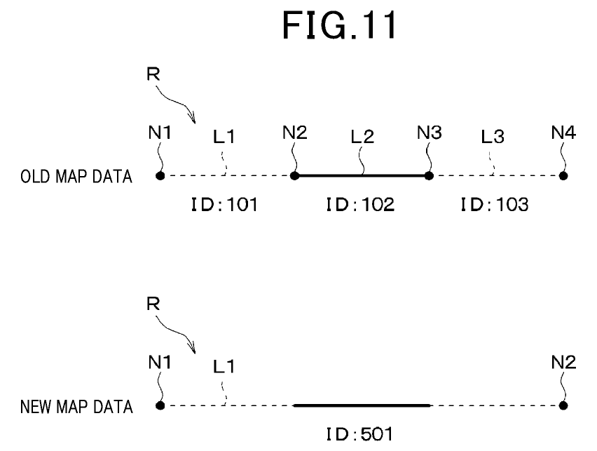

FIG. 11 shows a specific example corresponding to such an aspect. That is, in this example, the old map data is the same as in the example illustrated in FIG. 4. Further, the first node N1 is identical between the old map data and the new map data. On the other hand, in the new map data, a node corresponding to the fourth node N4 in the old map data is the second node N2, and it is assumed that no node N exists between the first node N1 and the second node N2. In the new map data, a first link L1 is formed between the first node N1 and the second node N2.

In this case, identity is determined between link information as a whole from the first node N1 to the fourth node N4 in the old map data and link information of the first link L1 between the first node N1 and the second node N2 in the new map data. When the identity is recognized, the autonomous driving availability information is associated with a partial section of the first link L1 in the new map data that corresponds to the second link L2 in the old map data.

It goes without saying that the elements constituting the above embodiments are not necessarily essential unless explicitly stated to be essential or unless they are clearly understood to be essential in principle. In addition, when a numerical value such as the number, value, amount, or range of a component in any of the above-described embodiments is mentioned, it should not be construed as being limited to that specific number or value unless expressly stated otherwise or unless it is clearly limited in principle. Furthermore, when the shape, direction, positional relationship, or the like of a component in any of the embodiments is described, it is not intended to be limited thereto unless explicitly stated otherwise or unless such limitation is clearly required in principle.

Expressions such as "acquire," "calculate," "estimate," "detect," "sense," and "determine" may be used interchangeably, provided that no technical inconsistency arises. Similarly, "detect," "sense," and "extract" may also be used interchangeably within a technically consistent scope. Furthermore, the expressions "exceeding a threshold" and "equal to or greater than a threshold" may be used interchangeably as long as they do not cause technical contradiction. The same applies to "less than a threshold" and "equal to or less than a threshold." The term “storage medium” may also be rephrased as “recording medium”. That is, a non-transitory tangible storage medium may also be referred to as a non-transitory recording medium.

The modifications are not limited to the examples described above. For example, all or part of one of the example modifications may be combined with all or part of another, as long as there is no technical contradiction. Furthermore, any or all of the specific examples described above may be combined with any or all of the above example modifications, provided that no technical contradiction arises.

What is claimed is:

1. An information processing device for processing map data used for autonomous driving of a vehicle, the map data including node information regarding a plurality of nodes corresponding to points on a road and link information regarding links connecting the nodes, each link connecting a pair of adjacent nodes among the plurality of nodes, the information processing device comprising:
a map data updater configured to update the map data stored in a map database from old map data to new map data;
an update determiner configured to perform an update determination as to whether autonomous driving availability information associated with the link information is updatable, based on a degree of match between the link information in the old map data and the link information in the new map data; and
an availability-information updater configured to carry over, from the old map data to the new map data, the autonomous driving availability information associated with the link information determined to be updatable by the update determiner.

2. The information processing device of claim 1, wherein the update determiner is configured to determine the degree of match based on shape information of each link.

3. The information processing device of claim 2, wherein the update determiner is configured to determine the degree of match based on attribute information of the road.

4. The information processing device of claim 1, wherein the update determiner is configured to determine the degree of match based on identity of identification-number information assigned to each link.

5. The information processing device of claim 1, wherein the availability-information updater discards the autonomous driving availability information associated with the link information determined to be not updatable by the update determiner.

6. An information processing method for processing map data used for autonomous driving of a vehicle, the map data including node information regarding a plurality of nodes corresponding to points on a road and link information regarding links connecting the nodes, each link connecting a pair of adjacent nodes among the plurality of nodes, the information processing method comprising:
updating the map data stored in a map database from old map data to new map data;
performing an update determination as to whether autonomous driving availability information associated with the link information is updatable, based on a degree of match between the link information in the old map data and the link information in the new map data; and
carrying over, from the old map data to the new map data, the autonomous driving availability information associated with the link information determined to be updatable as a result of the update determination.

7. The information processing method of claim 6, wherein performing the update determination comprises determining the degree of match based on shape information of each link.

8. The information processing method of claim 7, wherein performing the update determination comprises determining the degree of match based on attribute information of the road.

9. The information processing method of claim 6, wherein performing the update determination comprises determining the degree of match based on identity of identification-number information assigned to each link.

10. The information processing method of claim 6, wherein
carrying over, from the old map data to the new map data, the autonomous driving availability information further comprises discarding the autonomous driving availability information associated with the link information determined to be not updatable as a result of the update determination.

11. A computer program product comprising instructions which, when executed by a computer, cause the computer to carry out a method for processing map data used for autonomous driving of a vehicle, the map data including node information regarding a plurality of nodes corresponding to points on a road and link information regarding links connecting the nodes, each link connecting a pair of adjacent nodes among the plurality of nodes, the method comprising:
updating the map data stored in a map database from old map data to new map data;
performing an update determination as to whether autonomous driving availability information associated with the link information is updatable, based on a degree of match between the link information in the old map data and the link information in the new map data; and
carrying over, from the old map data to the new map data, the autonomous driving availability information associated with the link information determined to be updatable as a result of the update determination.

12. The computer program product of claim 11, wherein performing the update determination comprises determining the degree of match based on shape information of each link.

13. The computer program product of claim 12, wherein performing the update determination comprises determining the degree of match based on attribute information of the road.

14. The computer program product of claim 11, wherein performing the update determination comprises determining the degree of match based on identity of identification-number information assigned to each link.

15. The computer program product of claim 11, wherein carrying over, from the old map data to the new map data, the autonomous driving availability information further comprises discarding the autonomous driving availability information associated with the link information determined to be not updatable as a result of the update determination.

16. The computer program product of claim 11, wherein the computer program product is a
non-transitory tangible storage medium.
